(19) United States
(12) Patent Application Publication
(10) Pub. No.: US 2026/0326750 A1
(43) Pub. Date: Oct. 22, 2026

(54) DRIVER ASSISTANCE APPARATUS AND NON-TRANSITORY RECORDING MEDIUM

(71) Applicant: SUBARU CORPORATION, Tokyo (JP)

(72) Inventors: Harunobu HORIGUCHI, Tokyo (JP); Junichi SATO, Tokyo (JP); Shigeki OGAWA, Tokyo (JP); Takahito ISOBE, Tokyo (JP); Yuusuke SAKATA, Tokyo (JP)

(21) Appl. No.: 19/540,038

(22) Filed: Feb. 13, 2026

(30) Foreign Application Priority Data
Mar. 3, 2025 (JP) 2025-032948

(51) Int. Cl. B60W 30/09; B60W 30/16; B60W 50/14

(52) U.S. Cl. CPC B60W 30/09; B60W 30/16; B60W 50/14; B60W 2540/12

(57) ABSTRACT

A driver assistance apparatus configured to be applied to a vehicle is configured to assist a driver in driving the vehicle. The driver assistance apparatus includes one or more processors and one or more memories communicably coupled to the one or more processors. The one or more processors are configured to: determine whether automatic braking adapted to decelerate the vehicle to a target decreased vehicle speed is being executed; upon determining that the automatic braking is being executed, detect an accelerator operation amount produced by the driver; detect an accelerator override by comparing the detected accelerator operation amount and an override determination threshold; upon detecting the accelerator override, interrupt the automatic braking; upon interrupting the automatic braking, determine whether sudden braking is necessary; and upon determining that the sudden braking is necessary, cancel the accelerator operation amount and restart the automatic braking.

### CROSS-REFERENCE TO RELATED APPLICATIONS

The present application claims priority from Japanese Patent Application No. 2025-032948 filed on Mar. 3, 2025, the entire contents of which are hereby incorporated by reference.

### BACKGROUND

The disclosure relates to a driver assistance apparatus and a non-transitory recording medium.

A driver assistance apparatus configured to execute automatic braking control has been known. Upon determining that a vehicle is likely to come into contact with an obstacle detected ahead of the vehicle, the automatic braking control of this kind controls the vehicle to decelerate and automatically stop before the obstacle. The automatic braking control executes automatic braking also in stopping the vehicle at a traffic signal or before an intersection.

When the vehicle is about to enter a corner, the automatic braking control sets a target vehicle speed adapted to take the corner, based on a vehicle speed of the vehicle and a curvature of the corner. Upon determining that the vehicle speed of the vehicle exceeds the target vehicle speed, the automatic braking control automatically decreases the vehicle speed of the vehicle to the target vehicle speed. The automatic braking control executes the automatic braking also when a driver who drives the vehicle erroneously depresses an accelerator pedal instead of a brake pedal.

A control apparatus (a driving support apparatus) disclosed in Japanese Unexamined Patent Application Publication (JP-A) No. 2019-182314 releases automatic braking upon estimating that depression of an accelerator pedal by a driver who drives a vehicle is his/her intentional operation (a so-called accelerator override), not erroneous depression of the accelerator pedal instead of a brake pedal.

### SUMMARY

An aspect of the disclosure provides a driver assistance apparatus configured to be applied to a vehicle. The driver assistance apparatus is configured to assist a driver in driving the vehicle. The driver is a person who drives the vehicle. The driver assistance apparatus includes one or more processors and one or more memories communicably coupled to the one or more processors. The one or more memories are configured to hold a program to be executed by the one or more processors. The one or more processors are configured to, by operating in accordance with the program: determine whether automatic braking adapted to decelerate the vehicle to a target decreased vehicle speed is being executed, the target decreased vehicle speed including a target vehicle speed that the vehicle is to reach at a target arrival point ahead of the vehicle; upon determining that the automatic braking is being executed, detect an accelerator operation amount produced by the driver; detect an accelerator override by comparing the detected accelerator operation amount and an override determination threshold; upon detecting the accelerator override, interrupt the automatic braking; upon interrupting the automatic braking, determine whether sudden braking adapted to cause the vehicle to decelerate and reach the target arrival point at the target decreased vehicle speed is necessary; and upon determining that the sudden braking is necessary, cancel the accelerator operation amount and restart the automatic braking.

An aspect of the disclosure provides a non-transitory computer-readable recording medium containing a computer program configured to be applied to a driver assistance apparatus. The driver assistance apparatus is configured to assist a driver in driving the vehicle. The driver is a person who drives the vehicle. The computer program causes, when executed by one or more processors, the one or more processors to implement a method. The method includes: determining whether automatic braking adapted to decelerate the vehicle to a target decreased vehicle speed is being executed, the target decreased vehicle speed including a target vehicle speed that the vehicle is to reach at a target arrival point ahead of the vehicle; upon determining that the automatic braking is being executed, detecting an accelerator operation amount produced by the driver; detecting an accelerator override by comparing the detected accelerator operation amount and an override determination threshold; upon detecting the accelerator override, interrupting the automatic braking; upon interrupting the automatic braking, determining whether sudden braking adapted to cause the vehicle to decelerate and reach the target arrival point at the target decreased vehicle speed is necessary; and upon determining that the sudden braking is necessary, canceling the accelerator operation amount and restarting the automatic braking.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating an exemplary configuration of a vehicle mounted with a driver assistance apparatus according to one example embodiment of the disclosure.

FIG. 2 is a block diagram illustrating a driver assistance processor in the driver assistance apparatus illustrated in FIG. 1.

FIG. 3 is a flowchart illustrating an exemplary routine of driver assistance control to be executed by the driver assistance apparatus illustrated in FIG. 1 upon detecting an accelerator override during automatic braking.

FIG. 4 is a timing chart illustrating an exemplary flow of the driver assistance control to be executed by the driver assistance apparatus illustrated in FIG. 1 upon detecting the accelerator override during the automatic braking.

### DETAILED DESCRIPTION

Upon estimating that depression of an accelerator pedal by a driver who drives a vehicle is his/her intentional operation, a driving support apparatus disclosed in JP-A No. 2019-182314 does not restart automatic braking even if the vehicle is highly likely to come into contact with an obstacle.

A conceivable case, however, is that the driver erroneously depresses the accelerator pedal instead of a brake pedal after the driving support apparatus uniformly releases the automatic braking upon detecting an accelerator override during the automatic braking. Even in this case, the automatic braking is not restarted, which can make the driver panic.

It is desirable to provide a driver assistance apparatus for a vehicle and a non-transitory recording medium that each make it possible to prevent a driver who drives a vehicle from panicking, even upon detecting an accelerator override executed by intentional or erroneous depression of an accelerator pedal by the driver during automatic braking.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

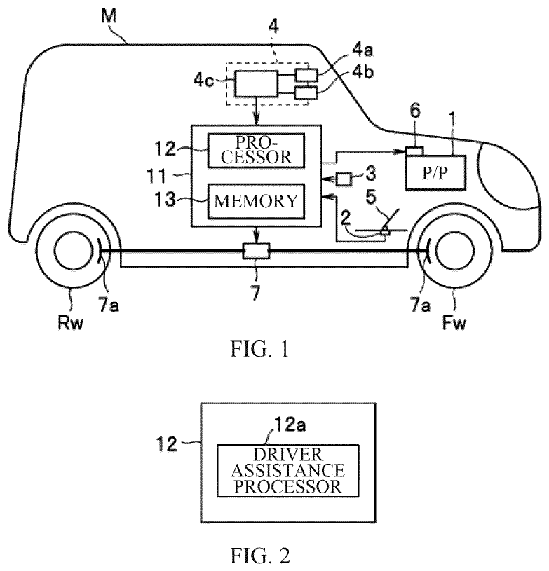

Referring to FIG. 1, a vehicle M may be mounted with a power plant 1. The power plant 1 may include a drive source such as an engine or an electric motor, and a transmission. The vehicle M may further be mounted with a driver assistance apparatus 11.

The driver assistance apparatus 11 includes one or more processors 12 and one or more memories 13 coupled to the one or more processors 12. In some embodiments, the processor 12 may include a central processing unit (CPU). In some embodiments, the CPU may be replaced by a field-programmable gate array (FPGA), a graphics processing unit (GPU), or a graph streaming processor (GSP). In some embodiments, the CPU, the FPGA, the GPU, and the GSP may be selectively combined for use.

In some embodiments, the memory 13 may include a read-only memory (ROM), a random-access memory (RAM), and a non-transitory recording medium such as a flash memory or an electrically erasable programmable read-only memory (EEPROM). The ROM may hold, for example but not limited to, programs and fixed data to be used for processes executed by the CPU. The RAM may serve as a work area of the CPU and temporarily hold various types of data to be used by the CPU.

To an input side of the driver assistance apparatus 11, an accelerator position sensor 2, a vehicle speed sensor 3, and a camera unit 4 may be coupled. The accelerator position sensor 2 may detect an accelerator operation amount produced by depression of an accelerator pedal 5 by a driver who drives the vehicle M, based on an accelerator position θacc. The vehicle speed sensor 3 may detect a vehicle speed Vs of the vehicle M.

The camera unit 4 may include a stereo camera including a main camera 4a and a sub-camera 4b, and an image processing unit (IPU) 4c. In some embodiments, the main camera 4a and the sub-camera 4b may each include an imaging device such as a charge-coupled device (CCD) or a complementary metal oxide semiconductor (CMOS). The main camera 4a and the sub-camera 4b may capture and acquire images of a travel environment ahead of the vehicle M. The images of the travel environment ahead of the vehicle M may be subjected to predetermined image processing by the IPU 4c and transmitted to a driver assistance processor 12a to be described later.

To an output side of the driver assistance apparatus 11, a drive source actuator 6 may be coupled. The drive source actuator 6 may vary an output of the drive source such as the engine or the electric motor. To the output side of the driver assistance apparatus 11, a hydraulic control unit (HCU) 7 may further be coupled. The HCU 7 may include, for example but not limited to, a pump that pressurizes or depressurizes a brake fluid, a pressure accumulator, and a solenoid valve that regulates a brake fluid pressure.

The HCU 7 may supply the brake fluid pressure to respective wheel cylinders of brake fluid pressure mechanisms 7a. The brake fluid pressure mechanisms 7a may be provided to respective ones of left-and right-front wheels Fw and left-and right-rear wheels Rw. In the present example embodiment, the brake fluid pressure mechanisms 7a may each be any known friction brake device such as a disc brake. The brake fluid pressure may be supplied from the HCU 7 to the respective wheel cylinders of the brake fluid pressure mechanisms 7a to thereby operate respective pistons of the wheel cylinders. As a result, a hydraulic braking force (a friction braking force) may be applied to the left-and right-front wheels Fw and the left-and right-rear wheels Rw.

Referring to FIG. 2, a computer program to be executed by the processor 12 of the driver assistance apparatus 11 may implement an operation to be performed by the driver assistance processor 12a. A computer program (a control program) to be executed by the driver assistance processor 12a may be held in the memory 13. The driver assistance processor 12a may execute various processes concerning driver assistance control such as autonomous emergency braking (AEB) control or adaptive cruise control (ACC) in accordance with the control program.

In some embodiments, the driver assistance processor 12a may perform automatic braking control in executing the AEB control. In some embodiments, the driver assistance processor 12a may perform the automatic braking control as part of vehicle speed control in executing the ACC control.

In one example of the AEB control, upon detecting a target object such as an obstacle, based on the images of the travel environment ahead of the vehicle M subjected to the image processing by the IPU 4c of the camera unit 4, the driver assistance processor 12a may determine a relative distance between a focal point Ph of the target object and the vehicle M and a relative speed between the target object and the vehicle M. The focal point Ph may be at a position, of the target object, closest to the vehicle M (i.e., a front end of the target object). Upon determining that the vehicle M is highly likely to come into contact with the obstacle as the target object, based on the relative distance and the relative speed, the driver assistance processor 12a may execute the automatic braking control under the AEB control to thereby stop the vehicle M before the focal point Ph set at the front end of the target object.

In one example of the ACC control, the driver assistance processor 12a may detect a relative speed and an inter-vehicle distance between the vehicle M and a preceding vehicle traveling immediately ahead of the vehicle M, based on the images of the travel environment ahead of the vehicle M subjected to the image processing by the IPU 4c of the camera unit 4. The driver assistance processor 12a may control the vehicle speed Vs of the vehicle M to cause the vehicle M to travel following the preceding vehicle while maintaining a constant inter-vehicle distance, based on the relative speed and the inter-vehicle distance between the vehicle M and the preceding vehicle traveling immediately ahead of the vehicle M.

The driver assistance processor 12a may adjust the vehicle speed Vs by operating the drive source actuator 6 and controlling the output of the drive source. At this time, when deceleration control with the drive source actuator 6 fails to maintain the inter-vehicle distance between the vehicle M and the preceding vehicle, the driver assistance processor 12a may execute the automatic braking control to thereby decelerate the vehicle M.

In another example of the ACC control, upon detecting a traffic signal ahead of the vehicle M, a light color of the traffic signal demanding a stop of vehicles, and a stop line present before an intersection ahead of the vehicle M, based on the images of the travel environment ahead of the vehicle M subjected to the image processing by the IPU 4c of the camera unit 4, the driver assistance processor 12a may decelerate and automatically stop the vehicle M at the stop line under the automatic braking control.

In still another example of the ACC control, when the vehicle M is about to enter a corner, the driver assistance processor 12a may set a target vehicle speed adapted to take the corner, based on the vehicle speed Vs and a curvature of the corner. Upon determining that the vehicle speed Vs is greater than the target vehicle speed, the driver assistance processor 12a may execute the automatic braking control to thereby decrease the vehicle speed Vs to the target vehicle speed.

In one example where the driver depresses the accelerator pedal 5 beyond a predetermined position during automatic braking, the driver assistance processor 12a may detect an accelerator override.

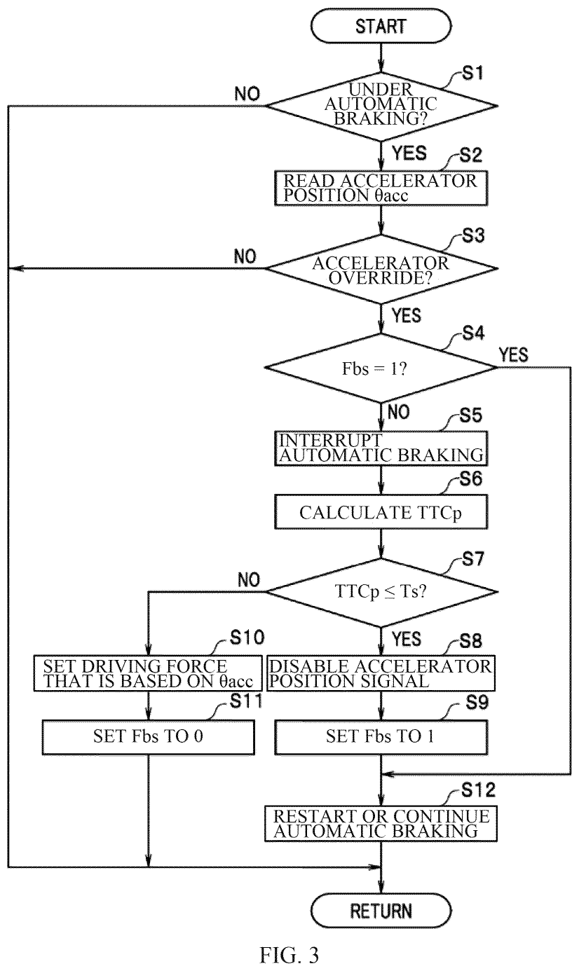

Upon detecting the accelerator override, the driver assistance processor 12a may interrupt the automatic braking. In the present example embodiment, when the accelerator override has been detected, the driver assistance control may be executed by the driver assistance processor 12a in accordance with a routine illustrated in FIG. 3.

In this routine, the driver assistance processor 12a may first determine whether the vehicle M is under the automatic braking (step S1). Upon determining that the vehicle M is not under the automatic braking (step S1: NO), the driver assistance processor 12a may cause the process to exit the routine. Upon determining that the vehicle M is under the automatic braking (step S1: YES), the driver assistance processor 12a may read the accelerator position θacc detected by the accelerator position sensor 2 (step S2).

Thereafter, the driver assistance processor 12a may detect the accelerator override by comparing the accelerator position θacc and an override determination threshold θo (step S3). The override determination threshold θo may be a value for the detection of the accelerator override that is a state in which the accelerator pedal 5 is intentionally depressed by the driver during the automatic braking.

Upon detecting the accelerator override (θacc≥θo) (step S3: YES), the driver assistance processor 12a may determine whether a braking restart flag Fbs is 1 by referring to a value of the braking restart flag Fbs (step S4). The braking restart flag Fbs may be set in step S9 to be described later and cleared in step S11 to be described later. Upon detecting no accelerator override (step S3: NO), the driver assistance processor 12a may cause the process to exit the routine and continue the automatic braking.

If the braking restart flag Fbs is 0 (Fbs=0) (step S4: NO), the driver assistance processor 12a may determine that the accelerator override is continued and cause the process to proceed to step S5. If the braking restart flag Fbs is 1 (Fbs=1) (step S4: YES), the driver assistance processor 12a may determine that the automatic braking has been restarted and cause the process to jump to step S12.

The driver assistance processor 12a may interrupt the automatic braking (step S5) and cause the process to proceed to step S6. The driver assistance processor 12a may calculate a target point arrival time TTCp (step S6). The target point arrival time TTCp may be calculated based on a known estimated time to contact (TTC).

The target point arrival time TTCp may be calculated by the following expression.

TTCp=((Do+Da)/Vo)−To

In the expression, Do may denote a target arrival point distance. The driver assistance processor 12a may set an avoidance leeway distance Da before the focal point Ph. The vehicle M may have a target arrival point P that is positioned before the focal point Ph and remote by the avoidance leeway distance Da from the focal point Ph. The target arrival point distance Do may be a distance between the target arrival point P and the vehicle M. Further, Vo may denote the relative speed between the vehicle M and the target object. When the target object is a stationary object such as an obstacle, the relative speed Vo may be equal to the vehicle speed Vs (Vo=Vs). When the vehicle M is to enter the corner, the avoidance leeway distance Da may be set before an entrance of the corner.

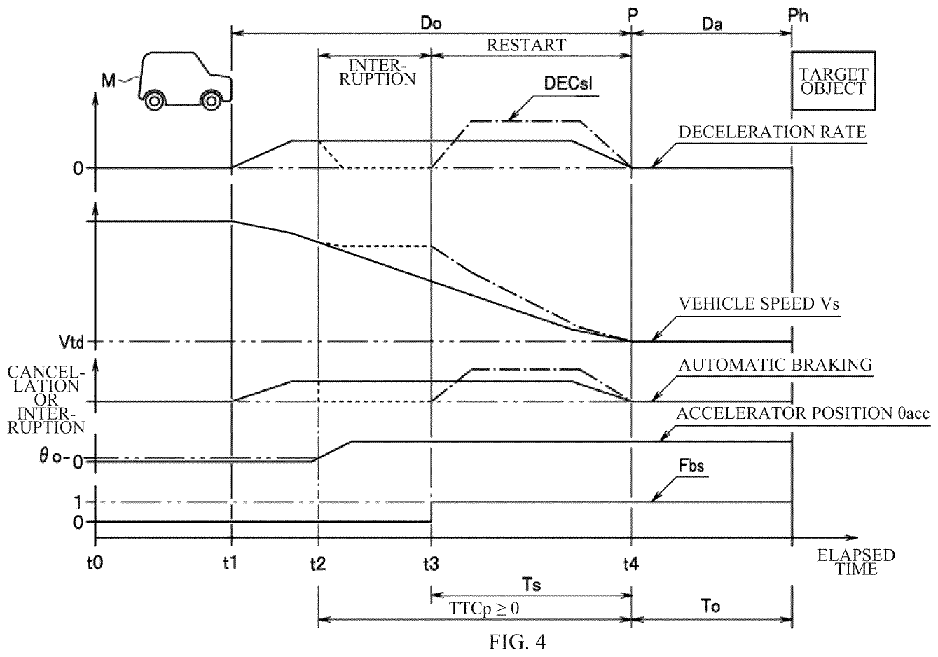

Furthermore, To may denote a contact avoidance leeway time illustrated in FIG. 4. The contact avoidance leeway time To may be a limit time that allows the driver to surely avoid the target object by performing a steering operation at the target arrival point P. In some embodiments, the contact avoidance leeway time To may be a fixed value. In one embodiment, the contact avoidance leeway time To may serve as a “leeway time”.

In one example where a target decreased vehicle speed Vtd illustrated in FIG. 4 at the target arrival point P is set to 18 [km/h] and the avoidance leeway distance Da is set to 5 [m], the contact avoidance leeway time To may be 1 [sec]. In some embodiments, when the vehicle M is about to enter the corner, the contact avoidance leeway time To may be a limit time that allows the driver to surely enter the corner by the steering operation.

Thereafter, the driver assistance processor 12a may determine whether the target point arrival time TTCp is less than or equal to a sudden braking limit time Ts by comparing the target point arrival time TTCp and the sudden braking limit time Ts (step S7). The sudden braking limit time Ts may be a limit time that allows the vehicle M to decelerate to the target decreased vehicle speed Vtd at the target arrival point P without causing sudden braking or a sharp increase in a deceleration rate gradient when the interruption of the automatic braking is continued. In some embodiments, the sudden braking limit time Ts may be a fixed value. In the present example embodiment, the sudden braking limit time Ts may be set to a value such as 1.8 [sec].

If the target point arrival time TTCp is less than or equal to the sudden braking limit time Ts (TTCp≤Ts) (step S7: YES), the driver assistance processor 12a may determine that the sudden braking is likely to be necessary. The driver assistance processor 12a may thus disable a signal of the accelerator position θacc detected by the accelerator position sensor 2 (step S8). Thereafter, the driver assistance processor 12a may set the braking restart flag Fbs (step S9) and cause the process to proceed to step S12. This may prevent a drive signal from being outputted from the driver assistance processor 12a to the drive source actuator 6 even if the driver depresses the accelerator pedal 5.

If the target point arrival time TTCp is greater than the sudden braking limit time Ts (TTCp>Ts) (step S7: NO), the driver assistance processor 12a may set a driving force that is based on the accelerator position θacc detected by the accelerator position sensor 2 (step S10), clear the braking restart flag Fbs (step S11), and cause the process to exit the routine. As a result, the driver assistance processor 12a may interrupt the automatic braking control, output the drive signal corresponding to a depression amount of the accelerator pedal 5 operated by the driver to the drive source actuator 6, and drive the drive source.

When the process proceeds from step S9 to step S12, the driver assistance processor 12a may restart the automatic braking and cause the process to exit the routine. When the process proceeds from step S4 to step S12, the driver assistance processor 12a may continue the restarted automatic braking and cause the process to exit the routine.

Upon determining that the automatic braking is to be restarted or continued in step S12, the driver assistance processor 12a may first set a target deceleration rate DECsl, based on the vehicle speed Vs, the target arrival point distance Do between the vehicle M and the target arrival point P, and the relative speed Vo between the vehicle M and the target object (the relative speed Vo is equal to the vehicle speed Vs if the target object is the stationary object). The target deceleration rate DECsl may be a target value adapted to decelerate the vehicle M to the target decreased vehicle speed Vtd at the target arrival point P, as illustrated in FIG. 4.

Thereafter, the driver assistance processor 12a may calculate the brake fluid pressure corresponding to the target deceleration rate DECsl. Thereafter, the driver assistance processor 12a may transmit a drive signal corresponding to the calculated brake fluid pressure to the HCU 7. Thereafter, the HCU 7 may regulate the brake fluid pressure by driving the pump and the solenoid valve in a hydraulic circuit. The brake fluid pressure regulated by the HCU 7 to a predetermined pressure may be supplied to the respective wheel cylinders of the brake fluid pressure mechanisms 7a. The automatic braking may be thereby restarted or continued.

Next, exemplary driver assistance control to be executed by the driver assistance processor 12a in accordance with the routine illustrated in FIG. 3 will be described with reference to a timing chart illustrated in FIG. 4. Note that, in the description, the target object is assumed to be the stationary object, such as a three-dimensional stationary object or the entrance of the corner, having a stationary focal point Ph. In FIG. 4, a solid line indicates an operation of normal automatic braking control, a dashed line indicates an operation to be performed upon detecting the accelerator override executed by the driver, and a dash-dot line indicates an operation to be performed upon restarting the automatic braking.

<Time Point t0>

Upon detecting the target object ahead of the vehicle M, the driver assistance processor 12a may set a deceleration start position, based on the target arrival point distance Do, the vehicle speed Vs, and the target decreased vehicle speed Vtd set at the target arrival point P.

<Time Point t1>

Upon arrival of the vehicle M at the deceleration start position, the driver assistance processor 12a may execute automatic deceleration control to thereby start deceleration of the vehicle M in accordance with a certain deceleration gradient characteristic. The driver assistance processor 12a may thus determine that the vehicle M is under the automatic braking (step S1: YES).

When the automatic braking has been started after the detection of the target object ahead of the vehicle M, the driver can feel that a timing of the deceleration is too early. When feeling that the timing of the automatic braking is early, the driver can depress the accelerator pedal 5 to thereby increase the vehicle speed Vs to a desired speed. Upon determining that the vehicle M is under the automatic braking (step S1: YES), the driver assistance processor 12a may detect the accelerator override by constantly comparing the accelerator position θacc detected by the accelerator position sensor 2 (read in step S2) and the override determination threshold θo (step S3).

<Time Point t2>

Upon detecting the accelerator override executed by the depression of the accelerator pedal 5 by the driver (θacc≥θo) (step S3: YES), the driver assistance processor 12a may interrupt the automatic braking (step S5). Thereafter, the driver assistance processor 12a may operate the drive source actuator 6 with the driving force corresponding to the accelerator position θacc detected by the accelerator position sensor 2. The vehicle speed Vs may be thereby increased, decreased, or maintained. Note that the dashed line in FIG. 4 indicates a state in which the vehicle speed Vs is kept constant with a deceleration rate (a negative acceleration rate) of 0 [m/s²].

<Time Point t3>

Thereafter, the driver assistance processor 12a may determine whether the target point arrival time TTCp is less than or equal to the sudden braking limit time Ts by comparing the target point arrival time TTCp and the sudden braking limit time Ts (step S7). If the target point arrival time TTCp reaches the sudden braking limit time Ts (step S7: YES), the driver assistance processor 12a may disable the drive signal that is based on the accelerator position θacc (step S8). Thereafter, the driver assistance processor 12a may restart the automatic braking (step S12). For example, the driver assistance processor 12a may decrease the vehicle speed Vs with the brake fluid pressure corresponding to the target deceleration rate DECsl, as indicated by the dash-dot line in FIG. 4.

As described above, when the driver depresses the accelerator pedal 5 during the automatic braking under the automatic braking control executed by the driver assistance processor 12a, the driver assistance processor 12a may detect the accelerator override (step S3: YES). However, upon thereafter determining that the target point arrival time TTCp is less than or equal to the sudden braking limit time Ts (TTCp≤Ts) (step S7: YES), the driver assistance processor 12a may cancel the depression of the accelerator pedal 5 by the driver (step S8).

Accordingly, upon determining that the target point arrival time TTCp is less than or equal to the sudden braking limit time Ts (TTCp≤Ts) after detecting the accelerator override executed by intentional or erroneous depression of the accelerator pedal 5 by the driver during the automatic braking under the automatic braking control performed by the driver assistance processor 12a, the driver assistance processor 12a may restart the automatic braking. This prevents the driver from panicking.

<Time Point t4>

When the vehicle M has decelerated and reached the target arrival point P at the target decreased vehicle speed Vtd, the driver assistance processor 12a may release the automatic braking. Illustrated in the timing chart of FIG. 4 may be a state in which the driver avoids the target object by the steering operation after the vehicle M has reached the target arrival point P. In this case, even if the driver depresses the accelerator pedal 5, the target decreased vehicle speed Vtd may be maintained until the vehicle M passes the target object.

In one example where the driver does not avoid the target object by the steering operation even after the vehicle M has reached the target arrival point P, the driver assistance processor 12a may execute the AEB control. This may forcibly stop the vehicle M before the target object.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having a similar meaning thereto are defined as being largely but not necessarily wholly what is specified as understood by one of ordinary skill in the art.

The term “disposed on/provided on/formed on” and its variants having a similar meaning thereto as used herein refer to elements disposed directly in contact with each other or indirectly by having intervening structures therebetween.

In some embodiments, the target object may be any mobile body such as a preceding vehicle, a bicycle, or a pedestrian.

In the foregoing example embodiment, the driver assistance processor 12a may determine whether to cancel the accelerator operation performed by the driver, by comparing the target point arrival time TTCp and the sudden braking limit time Ts in step S7. In some embodiments, the driver assistance processor 12a may compare the target deceleration rate DECsl and a predetermined deceleration-rate upper-limit threshold in step S7. If the target deceleration rate DECsl exceeds the deceleration-rate upper-limit threshold, the driver assistance processor 12a may restart the automatic braking.

According to at least one embodiment of the disclosure: upon detecting an accelerator override during automatic braking, the automatic braking is interrupted; upon interrupting the automatic braking, a determination is made as to whether sudden braking adapted to cause a vehicle to decelerate and reach a target arrival point at a target decreased vehicle speed is necessary; and upon determining that the sudden braking is necessary, an accelerator operation amount is canceled and the automatic braking is restarted. Such a configuration prevents the driver from panicking, even upon detecting the accelerator override executed by intentional or erroneous depression of an accelerator pedal by the driver during the automatic braking.

As used herein, the term “collision” may be used interchangeably with the term “contact”.

The driver assistance apparatus 11 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the driver assistance apparatus 11. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the driver assistance apparatus 11 illustrated in FIG. 1.

1. A driver assistance apparatus configured to be applied to a vehicle, the driver assistance apparatus being configured to assist a driver in driving the vehicle, the driver being a person who drives the vehicle, the driver assistance apparatus comprising:
one or more processors; and
one or more memories communicably coupled to the one or more processors, the one or more memories being configured to hold a program to be executed by the one or more processors, wherein
the one or more processors are configured to, by operating in accordance with the program,
determine whether automatic braking adapted to decelerate the vehicle to a target decreased vehicle speed is being executed, the target decreased vehicle speed comprising a target vehicle speed that the vehicle is to reach at a target arrival point ahead of the vehicle,
upon determining that the automatic braking is being executed, detect an accelerator operation amount produced by the driver,
detect an accelerator override by comparing the detected accelerator operation amount and an override determination threshold,
upon detecting the accelerator override, interrupt the automatic braking,
upon interrupting the automatic braking, determine whether sudden braking adapted to cause the vehicle to decelerate and reach the target arrival point at the target decreased vehicle speed is necessary, and
upon determining that the sudden braking is necessary, cancel the accelerator operation amount and restart the automatic braking.

2. The driver assistance apparatus according to claim 1, wherein the target arrival point is set before a target object.

3. The driver assistance apparatus according to claim 2, wherein the one or more processors are configured to, by operating in accordance with the program,
set a target point arrival time for the vehicle to reach the target arrival point by subtracting a predetermined leeway time from a time calculated based on a distance between the vehicle and the target object and a relative speed between the vehicle and the target object, and
determine whether the sudden braking is necessary by comparing the target point arrival time and a sudden braking limit time.

4. The driver assistance apparatus according to claim 2, wherein the one or more processors are configured to, by operating in accordance with the program,
calculate a target deceleration rate, based on a relative distance between the vehicle and the target arrival point and a relative speed between the vehicle and the target arrival point, and
determine whether the sudden braking is necessary by comparing the target deceleration rate and a deceleration-rate upper-limit threshold.

5. A non-transitory computer-readable recording medium containing a computer program configured to be applied to a driver assistance apparatus, the driver assistance apparatus being configured to assist a driver in driving the vehicle, the driver being a person who drives the vehicle, the computer program causing, when executed by one or more processors, the one or more processors to implement a method, the method comprising:
determining whether automatic braking adapted to decelerate the vehicle to a target decreased vehicle speed is being executed, the target decreased vehicle speed comprising a target vehicle speed that the vehicle is to reach at a target arrival point ahead of the vehicle;
upon determining that the automatic braking is being executed, detecting an accelerator operation amount produced by the driver;
detecting an accelerator override by comparing the detected accelerator operation amount and an override determination threshold;
upon detecting the accelerator override, interrupting the automatic braking;
upon interrupting the automatic braking, determining whether sudden braking adapted to cause the vehicle to decelerate and reach the target arrival point at the target decreased vehicle speed is necessary; and
upon determining that the sudden braking is necessary, canceling the accelerator operation amount and restarting the automatic braking.
